(19) United States
(12) Patent Application Publication
(10) Pub. No.: US 2002/0083005 A1
(43) Pub. Date: Jun. 27, 2002

(54) Media transaction processor

(76) Inventors: Stephen Lowenstein, Badhoevedorp (NL); Steven Craig, Little London (GB); Martin Irvin, Reading (GB); Christophe Gillet, Hoofdrorp (NL); Keith Bishop, Cambridge (GB); Jonathan James Stone, Reading (GB); Morgan William Amos David, Farnham (GB)

Correspondence Address: FROMMER LAWRENCE & HAUG LLP, 745 FIFTH AVENUE, NEW YORK, NY, 10151, US

(21) Appl. No.: 10/006,198

(22) Filed: Dec. 4, 2001

Related U.S. Application Data
(63) Continuation of application No. PCT/GB01/01493, filed on Apr. 2, 2001.

(30) Foreign Application Priority Data
Apr. 7, 2000 (GB) 0008720.5

(51) Int. Cl. G06F 17/60; H04K 1/00; H04L 9/00

(52) U.S. Cl. 705/57

(57) ABSTRACT

A multimedia transaction processor for facilitating the sale of multimedia material, the apparatus comprises a media server operable to store multimedia material from at least one vendor, and to store meta data representing the content of the multimedia material and data identifying the vendor providing the multimedia material, the meta data and the identifying data being stored in association with the multimedia material. The apparatus includes a communications processor connectable, via a communications link, to one or more data processing systems and is operable to receive via the communications link data indicative of a request for multimedia content from one of the buyers. An access processor is operable to retrieve from the server possible multimedia material content items corresponding to the requested multimedia content by generating meta data from the data requesting the multimedia content and comparing the generated meta data with the meta data stored in association with the multimedia material, and from the comparison retrieving the possible multimedia content items from the server. The communications processor communicates to the buyer data processing system data representative of the possible multimedia content items. A transaction controller is operable, in response to selection data, to communicate data requesting the selected multimedia content items to the vendor identified by the stored identification and to complete the transaction with the buyer. The transaction may be completed by arranging for money to be charged to the buyer. The multimedia transaction processor provides a facility for users to sell and to buy multimedia material in order to fulfil a particular need. The buyers have access to multimedia material items from any vendor which places media items on the transaction processor. Preferably the data communications link includes the Internet.

### FIELD OF INVENTION

The present invention relates to multimedia transaction processors which operate to provide a facility for buying and selling multimedia material.

### BACKGROUND OF THE INVENTION

The term multimedia material as used herein referrers to and includes any form of information material such as audio materials, video materials, audio/video material, as well as computer programs, games, and any data which provides information to users.

Multimedia material such as audio/video material, may be produced and consumed for a variety of different purposes. Although audio/video material may be used in various industries and for educational purposes, there is a particularly large demand for such material from the entertainment industry where an increase in the number of television channels, particular in Europe has fuelled an increase in the demand for audio/video productions. Furthermore, the availability of the personal computer to the average household has contributed to the demand for multimedia material for applications such as games, advertising and information material provided on the Internet.

### SUMMARY OF INVENTION

According to the present invention there is provided a multimedia transaction processor for facilitating the sale of multimedia material, the apparatus comprising a media server operable to store multimedia material from at least one vendor, meta data representing the content of the multimedia material and data identifying the vendor providing the multimedia material, the meta data and the identifying data being stored in association with the multimedia material, a communications processor connectable, via a communications link, to one or more data processing systems and operable to receive, via the communications link, from one of the data processing systems, data indicative of a request for multimedia content from a buyer, an access processor operable to retrieve from the server possible multimedia material content items corresponding to the requested multimedia content by generating meta data from the data requesting the multimedia content and comparing the generated meta data with the meta data stored in association with the multimedia material, and from the comparison retrieving the possible multimedia content items from the server, and to communicate to the buyer data processing system data representative of the possible multimedia content items, and a transaction controller operable, in response to selection data representative of a selection of at least one of the possible multimedia content items from the buyer, to communicate to the vendor identified by the stored identification, data ordering the selected multimedia content items, and to complete a sales transaction for the selected multimedia material with the buyer.

Although in the past it has been conventional for a production company, for example, to generate multimedia material (such as audio/video material) for a production itself, the demand for multimedia material and changes in the market for such material has resulted in consumers, using material generated from a variety of different sources. For example, in the case of audio/video material, the material may be produced by a freelance cameraman, or a production company which specialises in a particular field such as wild life photography. Correspondingly, there is an increasing variety in the consumers of multimedia material, which include production houses independent of television channels, games production houses, and advertising agencies.

The present invention provides a facility for both searching for multimedia material items which are suitable for a consumer's needs and selling multimedia material items selected by a consumer.

Typically, but not exclusively, the sales transaction for the purchase of the multimedia material may be effected, in some embodiments, by charging the buyer an amount of money which has been predetermined by the vendor. In some embodiments this is effected by arranging for the charge for the material to transferred from an account of the buyer to an account of the vendor. However, in other embodiments, the transaction may be completed by arranging for payment in kind to be transferred from the buyer to the vendor. In such embodiments, the payment in kind may not be money.

Conventionally, multimedia material such as audio/video material could only be viewed by communicating a storage medium to a potential buyer to sample the audio/video material on the storage medium. As will be appreciated, the material available for viewing is limited to that which a vendor has stored on the storage medium. The present invention provides an advantage in providing a facility for storing multimedia material from a plurality of vendors. In order to identify an appropriate item of multimedia material, an access processor provides a facility for searching for multimedia items according to a desired type produced from the plurality of vendors. Vendors can arrange for the multimedia material which they wish to sell to be stored on the media server in association with meta data which may be, for example, generated automatically at the time of the acquisition of the multimedia material. As such, a potential buyer of multimedia material can search for the multimedia material which is appropriate for a particular requirement using the meta data. Buyers therefore have access to multimedia material from a variety of vendors.

Although the communications link could be provided by any appropriate data communications network having a bandwidth to communicate multimedia material, in preferred embodiments the communications link includes an Intranet or an Internet such as the World Wide Web or the like. The buyers are therefore provided with a convenient way of accessing the multimedia material stored on the media server.

In preferred embodiments, the multimedia material stored on the server may include impairments. In one embodiment the impairments to the data representing the multimedia material stored on the server may be provided by reducing the amount of data representing the multimedia material, and as a result, reducing the quality of the representation of the multimedia material. Reducing the amount of data representing the multimedia material provides an advantage in reducing the amount of data which must be communicated to a buyer. Furthermore the reduction in quality discourages unauthorised use and copying of the material stored on the media server. In some embodiments the impairments may be formed by embedding data in the multimedia material. For the example of video material the data embedded in the video material may form a visible watermark.

In some embodiments data may be embedded into the material in order to provide a facility for identifying the owner of the material. The embedded data may therefore form a watermark, which may be imperceptible or at least difficult to perceive. The watermark may be in a form such as to deter a buyer from using the watermarked material. If an unscrupulous buyer were to copy the multimedia material, the watermark may be used to identify the owner of the material, so that copying may be more likely to be proven.

Although a vendor may offer the multimedia material for sale using the multimedia material transaction processor for a predetermined amount of money, other vendors may restrict the use of the material sold and/or stipulate more detailed rules for the sale of the material. As such, in preferred embodiments the media server may be operable to store business rules data representative of the conditions for the sale of selected multimedia material items, the access processor communicating the conditions of sale data to the buyer data processing system in response to either the selection data or the requesting data.

As will be appreciated from the foregoing discussion, in preferred embodiments the multimedia material may include audio/video material.

Various aspects and features of the present invention are defined in the appended claims.

### BRIEF DESCRIPTION OF THE DRAWINGS

FIG. 1 is a schematic representation of system for buying and selling multimedia material, according to a first embodiment of the present invention;

FIG. 2 is a schematic block diagram of a multimedia transaction processor shown in FIG. 1;

FIG. 3 is a part graphical, part schematic representation illustrating a relationship between the meta data searched and the multimedia material recovered using the multimedia transaction processor of FIG. 2;

FIG. 4A is a flow diagram illustrating the addition of new multimedia material to a media server of the multimedia transaction processor of FIG. 2, and FIG. 4B is a flow diagram representing the response of a vendor to the sale of media items;

FIG. 5A is a flow diagram illustrating a process whereby a user searches and selects multimedia material, and in FIG. 5B a flow diagram of a process in which a user buys multimedia material using the multimedia transaction processor of FIG. 2;

FIG. 6 is a schematic representation of a multimedia transaction processor according to a second embodiment of the present invention;

FIG. 7 is a schematic representation illustrating a system using the transaction processor of FIG. 6, in which a multimedia material stored on a media server of the transaction processor is accessed to generate a media production; and

FIG. 8 is a schematic representation illustrating a further example use of the system of FIG. 7.

### DESCRIPTION OF PREFERRED EMBODIMENTS

First Embodiment

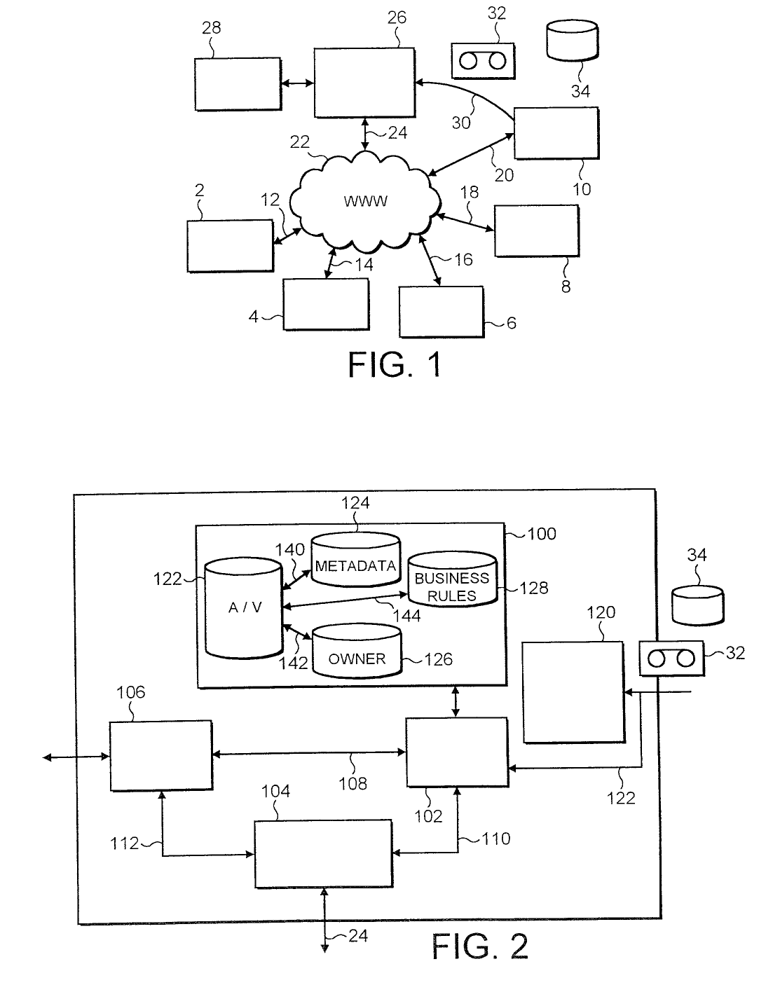

A system in accordance with an embodiment of the present invention in which multimedia material is bought and sold is illustrated in FIG. 1. In FIG. 1 data processing systems 2, 4, 6, 8, 10 are shown to be connected via bi-directional links 12, 14, 16, 18, 20 to a data communications network 22. The data communications network 22 may be any suitable network, which will provide a facility for communicating multimedia material, such as, for example audio/video material. As will be appreciated therefore, preferably the communications network 22 is a broadband communications network. However in preferred embodiments the data communications network 22 includes the Internet providing communications via the World Wide Web. Also connected to the data communications network 22 via a bi-directional link 24 is a multimedia transaction processor 26. Connected to the multimedia transaction processor 26 is an accounts management system 28.

Although the embodiments will be described for the example of audio/video material, this is just one example of multimedia material and other forms of material are envisaged.

The data processing systems 2, 4, 6, 8, 10 are associated with users of the transaction system illustrated in FIG. 1. The data processing systems may be personal computers or work stations or any other suitable data processing system running software programs which provide access to the data communications network 22 and through which a user can communicate data and receive and view audio/video material. Any of the users can arrange to either buy or sell audio/video material through the transaction processor 26. Accordingly a vendor (a user vending material) of multimedia material may be associated with one of the data processing systems. Correspondingly, a buyer (a user buying material) may be associated with another or the same data processing systems 2, 4, 6, 8, 10.

The users of the multimedia transaction system shown in FIG. 1 may be for example broadcast and distribution channels, production companies, freelance researchers, freelance camera men or freelance producers, all of which may either generate audio/video material or may consume audio/video material in the process of making a production. Consider for example the user which is associated with one of the data processing systems 10 which wishes to sell audio/video material. This data processing system therefore acts as a vendor data processing system. The vendor data processing system 10 communicates to the transaction processor 26 the multi-media material which it wishes to sell. Along with the multimedia material, the vending data processing system generates meta data which describes the content of the audio/video material which it wishes to sell. The meta data may be generated at the time of acquisition of the audio/video material. However in other embodiments the meta data may be generated in the transaction processor 26 from the audio/video material at a time at which the material is ingested by the transaction processor 26.

The audio/video material may be communicated to the transaction processor 26 via any convenient route which is represented in FIG. 1 by an arrow 30 via which the audio/video material stored on a data carrier 32 is communicated along with meta data stored on a further data carrier 34 to the transaction processor 26. In other embodiments the meta data and the audio/video material may communicate on the same data carrier. The transaction processor 26 is shown in more detail in FIG. 2 where parts also appearing in FIG. 1 have the same numerical references.

In FIG. 2 the transaction processor 26 is shown to comprise a media storage server 100 coupled to an access processor 102. The media storage server may include a redundant array of disks (not shown) to improve the reliability of the media storage system. The access processor may be formed from a software module running on a work station. The access processor is coupled to a communications processor 104 and to a transaction controller 106 via two communications channels 108, 110. Again the communications processor 104 and the transaction controller 106 may be implemented as software modules running on different or the same computer system. The transaction controller 106 is also coupled to the communications processor via a further communications channel 112.

Although the media storage server 100, the access processor 102, the communications processor 104, and the transaction controller 106 which form the transaction processor 26 are shown together, it will be appreciated that in other embodiments the parts of the transaction processor could be located remotely. For such embodiments, the communications channels are arranged to communicate data between these parts from distributed locations.

Vending Material

As shown in FIG. 2 the data carriers 32, 34 are received within the transaction processor 26 by an ingestion processor 120. The ingestion processor 120 is coupled to the access processor 102 by an internal communications channel 122. The ingestion processor 120 is arranged to recover the audio/video material from the data carrier 32 and the meta data from the data carrier 34 and to feed the recovered audio/video material and meta data to the access processor 102 via the communications channel 122. The access processor is arranged to store the audio/video material and the meta data in the server 100. The audio/video material is stored in the server 100 in a first a/v data store 122. The meta data is stored in a second meta data store 124 in association with the audio/video material stored in the a/v data store 122 as represented schematically by an arrow 140 between the a/v and meta data stores 122, 124.

Also included with the audio/video material carried on the data carrier 32, or the meta data carrier 34 received from the vending processor 10 is data identifying the vending processor. The data identifying the vendor is ingested and stored by the access processor 102 in a third ownership data store 126 in association with the audio/video material, as represented by a further arrow 142 between the a/v data store 122 and the ownership data store 126. Although these are shown as separate data stores, in an alternative implementation they could be the same data store.

The server 100 is arranged to the effect that the audio/video material can be accessed using the meta data stored in the meta data store 124 and the owner of any of the audio/video material stored in the a/v data store 122 can be determined from the data identifying the vendor which is stored in the ownership data store 126. The term ownership is used here to identify the vendor. The vendor may not own the material, but may be vending the material on behalf of the owner of the material.

The vendor indicates charging information for the audio/video material and, in addition, in some embodiments may also stipulate conditions under which the audio/video material may be sold or used after it has been sold. Accordingly the vending data processor may communicate data representing business rules or licensing conditions for the use and sale of the audio/video material. This charging information and business rules are ingested by the ingestion processor 120 and stored in the server 100 via the access processor 102. To this end, a fourth business rules data store 128 is provided for storing data representative of the business rules. The server 100 is again arranged in combination with the access processor 102 to store the charging information and optionally the business rules in association with the audio/video material to which the rules relate.

In some embodiments the ingestion processor may be operable to convert the audio/video material into a degraded form providing a lower quality representation of the material. This is typically provided to the effect that an amount of data required to represent the audio/video material is substantially reduced. Accordingly, the representation of the audio/video material may be communicated using a smaller amount of communications bandwidth.

Converting the audio/video material into a lower quality representation also provides an advantage in discouraging a buyer from using the representation of the audio/video material without paying for the audio/video material.

In order to trace and prove unauthorised copying of the audio/video material, a vendor may embed data into the audio/video, to form what is commonly referred to as a watermark. The watermark may include a Universal Material Identifier (UMID) which may be uniquely associated with an item of audio/video material and therefore provides a facility for proving ownership so appropriate action against copyright infringement may be taken.

Buying Material

Returning to FIG. 1, any one of the users associated with the data processing systems 2, 4, 6, 8, 10 may obtain audio/video material from the transaction processor 26 by communicating with the transaction processor 26 via the data communications network (World Wide Web) 22. Any one of the users associated with the data processing systems 2, 4, 6, 8, 10 may search and purchase audio/video material from the transaction processor 26. Accordingly when the user data processing systems act to buy audio/video material they will be referred to in the following description as buyer data processing systems.

A buyer data system wishing to purchase a particular item of audio/video material must first find a suitable audio/video material item which suits the user's requirements. For example, the buyer data processing system may be associated with an advertising agency which requires a particular clip associated with, for example, motor sport. The buyer data processing system therefore sends data representative of “motor sport” in a form which will be recognised by the transaction processor 26. The buyer data processing system communicates this data via the data communications network 22 to the communications processor 104 in the transaction processor 26. The communications processor 104 recognises the received data from the buyer as a request for material corresponding generally to the description “motor sport”. The communications processor controls and communicates this data to the access processor 102. The access processor 102 generates meta data corresponding to the requested “motor sport” material and uses the generated meta data to search the meta data store 124 for meta data corresponding or matching this meta data. The access processor 102 then retrieves audio/video material which is found to match the searched meta data produced by the access processor 102. The access processor 102 then retrieves the audio/video material corresponding to a possible match for the requested “motor sport” audio/video material and communicates the audio/video material via the communications processor 104 and the data communications network 22 to the buyer.

The buyer may then review the audio/video material and determine which of the possible audio/video material items are suitable for the clip relating to motor sport. Accordingly, the buyer data processing system may then communicate data representing a desired selection of the possible audio/video material items received from the transaction processor 26. The communications processor 104 recognises the received data selecting the desired audio/video material items or items and communicates and arranges for the transaction controller 106 to debit the account of the buyer in accordance with the charge for the audio/video material, pre-stored in the business rules data store 128 of the server 100. The buyer's bank account is debited by the transaction controller from the account management system 28.

As already mentioned, the business rules data store 128 which stores the business rules for the sale of the audio/video material may include further conditions for the sale of the audio/video material and/or use of this material. Therefore, in response to the selection data the transaction processor 26 may arrange to communicate the rules for the purchase and use of the audio/video material to the buyer data processing system. As such, a further stage may be required in the process for purchasing the audio/video material in order that the buyer must accept the conditions for use and sale before the purchase transaction is completed.

After the buyer's account is debited with the appropriate amount of money, the transaction controller 106 arranges for the vendor data processing system to receive an order for the audio/video material indicating which audio/video material is being purchased, the amount of this material and an identification of the buyer data processing system. The vendor then sends the audio/video material to the buyer via any appropriate route. For example the audio/video material may be communicated on a data storage medium in the post. Alternatively, the audio/video material may be communicated via the data communications network 22, including the Internet.

Browsing, Previewing and Selecting

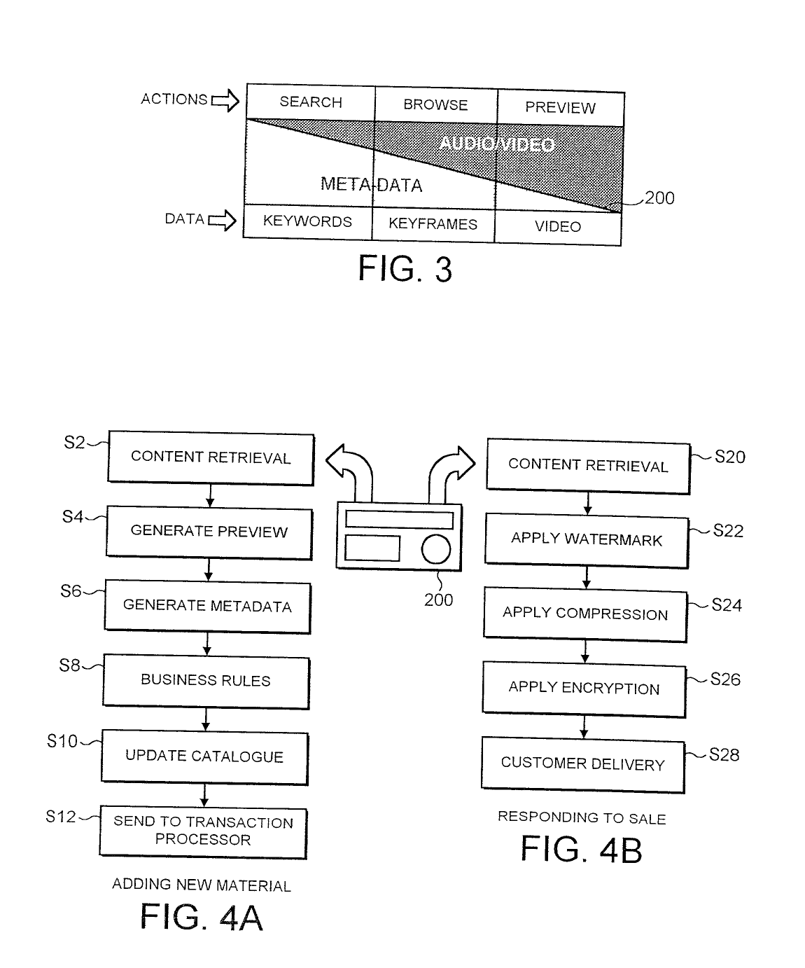

The embodiment described above represents a relatively simple transaction in which the buyer can identify the audio/video material it desires from the audio/video material communicated to it by the transaction processor 26. However, in alternative embodiments the access processor 102 may communicate the meta data generated in response to the data requesting material, to the buyer data processing system for further selection and refinement. Accordingly, after some of the meta data has been selected, items of audio/video material retrieved as a result of searching the media storage server with the selected meta data may be communicated to the buyer by the transaction processor 26 by retrieving the audio/video material corresponding to the selected meta data. As will be appreciated therefore a relationship exists between the amount of meta data generated and selected and the audio/video material selected, previewed and browsed before the desired audio/video material is selected. The relationship is represented graphically in FIG. 3 where the line 200 illustrates the change between the amount of meta data selected and communicated to the buyer and the amount of audio/video material, as the buyer refines its choice of retrieved audio/video material.

In preferred embodiments, the buyer data processing system, after viewing a possible audio/video material item, may decide that only a particular part of the audio/video material item is appropriate for its requirements. As such the audio/video clip may include data representing a time line. The buyer may then select a part of the audio/video clip to meet its requirements with respect to the time line. The buyer therefore communicates data representing the desired part from the selected audio/video material item to the transaction processor 26. Accordingly, the communications processor 104 operates in combination with the transaction controller 106 to debit an amount of money corresponding to the proportion of the clip amount of the audio/video clip which was selected by the buyer, with respect to the charge for the entire clip.

Catalogue of Material

In other embodiments, the access processor may control the server to the effect of organising the audio/video material into particular categories. Such categories may be associated by vendor and/or by subject matter. The access processor may then generate data representative of each of the categories, and further data generated to represent a list of available categories. The data representing the list of categories and the categories themselves may be communicated to the buyer data processing systems on request to facilitate browsing and selection of a desired audio/video material items.

A further facility provided by the access processor is to log a number of audio/video material items which are previewed and bought from, for example, those provided by a particular vendor. Using this information, the access processor can send a profile indicating the relative demand for the audio/video material items which a vendor has lodged with the transaction processor.

Summary of Operation

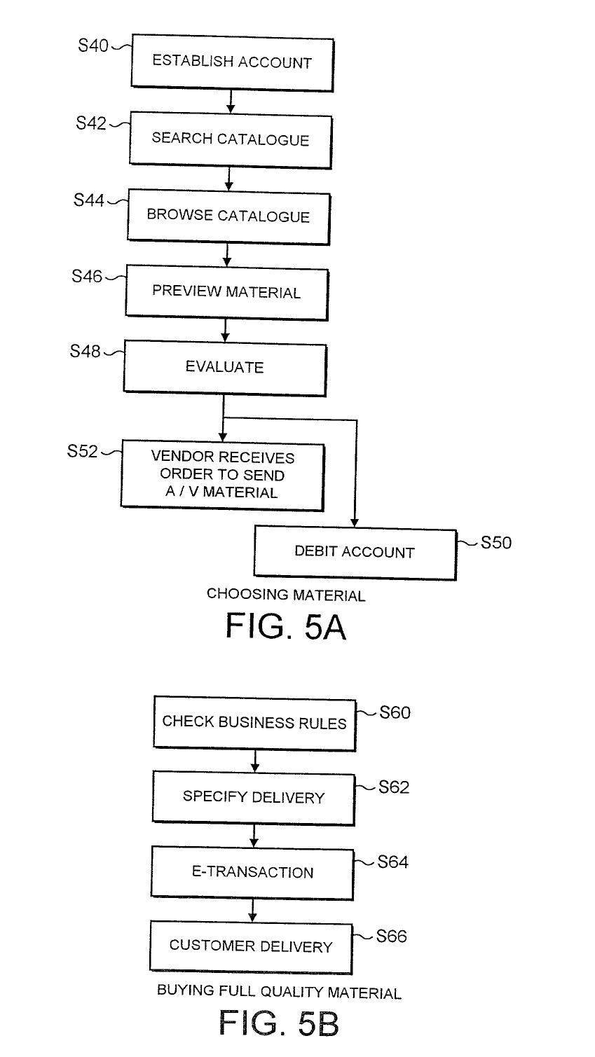

In summary the process steps taken by a buyer data processing system and a vendor data processing system will now be described with reference to FIGS. 4A, 4B and 5A, 5B.

The steps taken for a vendor are depicted in FIGS. 4A and 4B. FIG. 4A represents a flow diagram of the process to add new material to the transaction processor, whereas FIG. 4B represents the steps taken by the vendor in response to a request for sale of the audio/video material.

In order to add new material to the transaction processor, the vendor first retrieves S2, the content from an asset management system 200. At step S4 a preview of the audio/video material is generated which is suitable for storing on the transaction processor. The preview material may include a watermark in order to identify the owner of the audio/video material. The preview material may be converted into a reduced quality representation of the audio/video material to provide a reduction in quality in order to discourage copying. At step S6 meta data representative of the content of the audio/video material is generated. Examples of meta data are provided in our co-pending patent application Ser. No. 0008432.7. However as will be appreciated the meta data may itself be generated at acquisition of the audio/video material and so may be simply reproduced from the asset management system 200. At step S8 the charge information and the business rules corresponding to the use and sale of the audio/video material are identified. At step S10, a vendor catalogue is identified in which the audio/video material available from that vendor is added to a catalogue comprising all audio/video material which is available from that vendor. At step S12 the audio/video preview data, the meta data corresponding to this preview, the business rules for the sale and use of the audio/video material and the catalogue update data are communicated for ingestion into the transaction processor. In accordance with the embodiment represented by the flow diagram in FIG. 4A, the data generated by the vendor is in a form in which it can be loaded directly by the access processor 102 onto the server 100 and therefore the ingestion processor 120 can be bypassed.

The steps taken by a buyer are represented in FIGS. 5A and 5B. In FIG. 5A at step S40 the user establishes an account with the account management system 28. This can be achieved by communicating with the communications processor 104 via the buyer data processing system. At this point the buyer may be required to deposit money into the account in preparation for purchasing audio/video material. At step S42 the buyer accesses the transaction processor 26 by communicating a request for audio/video material represented as either meta data or data identifying the type of material which is required. Accordingly, meta data matching the requested material is communicated to the buyer. Alternatively, or in addition, a catalogue representative of possible matches of audio/video material, may be communicated to the buyer data processing system at step S42. At step S44 the catalogue is browsed by the buyer and after selecting possible candidates suitable for it's requirements, the buyer previews the audio/video material (step S46). At process step S48 the desired audio/video material is evaluated and data representing the selected audio/video material is communicated to the transaction processor 26. At step S50 the buyer's account is debited with an amount of money determined by the business rules provided by the vendor. Contemporaneously, an order for the audio/video material is sent to the vendor is executed at step S52.

The steps taken in response to the vendor receiving a request for audio/video material is represented in FIG. 4B. In FIG. 4B the vendor retrieves the selected audio/video material from the asset management system 200, S20. At step S22 the vendor applies a watermark to the audio/video material and at step S24 the watermarked material is compression encoded and encrypted at step S26. A watermark is added to the audio/video material and compression encoded and encrypted in order to provide security when the audio/video material is communicated to the buyer. The decryption process and decryption key are also communicated via a separate route so that the buyer can decompress the data to recover the watermarked audio/video material.

The watermark added by the vendor may be removed or washed from the audio/video material by supplying the buyer with a key for removing the watermark and the knowledge of how the watermark was applied to the audio/video material. At step S28 the audio/video material is delivered to the buyer by an appropriate means. If as in the present example the audio/video material has been watermarked, compression encoded and encrypted, then the audio/video material can be communicated via the World Wide Web to the buyer at step S28.

Returning to FIG. 5B, once the buyer has selected the desired audio/video material then at step S60 the buyer checks the business for the purchase and use of the audio/video material. If these are in accordance with the requirements of the buyer then at step S62 the buyer identifies a specific delivery of the form in which the audio/video material is to be communicated. This may be via the World Wide Web or via a data carrier delivered by the postal system. At step S64 the electronic transaction is performed in order to debit the buyer's account with the predetermined amount of money, and the buyer then receives the material from the vendor at step S28.

Second Embodiment

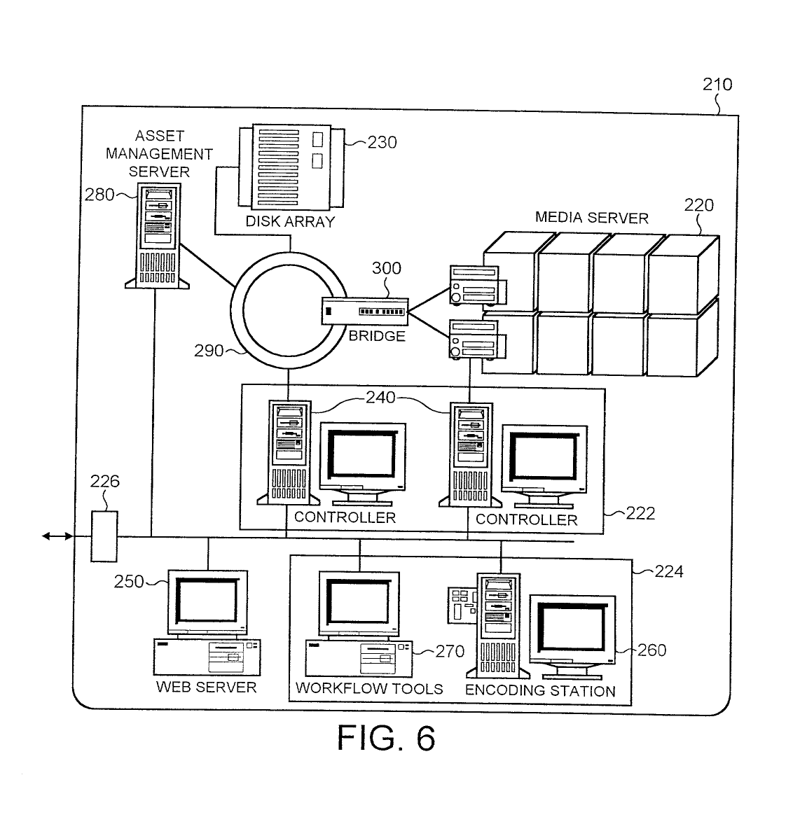

The first embodiment described above assumes that the buying and vendors are operationally autonomous and have no predetermined collaboration. However if a collaboration exists between the users of the transaction processor, such as for example if each is engaged in a different stage of producing an audio/video production, then the transaction processor may be used as a remote store for audio/video material. Such an alternative embodiment of the transaction processor is shown in FIG. 6.

FIG. 6 is a schematic diagram of a transaction processor 210 according to a further embodiment of the present invention. The transaction processor 210 comprises a media storage server 220, an access processor 222, an ingestion processor 224 and a communications processor 226, which operate substantially in the same way as the first embodiment described above. As shown in FIG. 6, the media storage server 220 is connected via a bridge 300 providing communications via a local communications network 290 to a disk array 230 such as a high capacity RAID disc array. The access processor 222 comprises server controllers 240 and an asset management system 280. The ingestion processor comprises an encoding station 260, a work flow tools work station 270.

As with the first embodiment, the transaction processor 210 connects to an external data communications network such as, for example, a dedicated high capacity data link or the Internet, via the communications processor 226. To this end the communications processor 226 includes a web server 250.

The encoding station, the work flow tools station and the controllers are computer devices running appropriate software to handle administration of the loading and unloading of data to the media server. The web server provides an interface to the internet (if one is indeed used) and handles the management and presentation of web pages and the like.

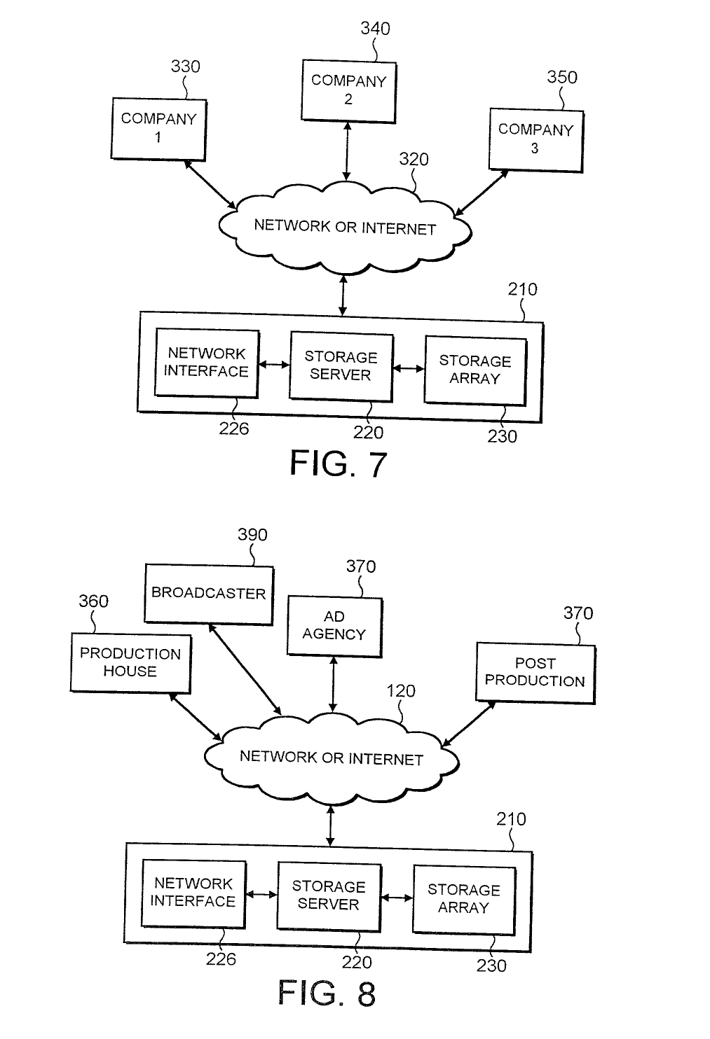

FIG. 7 is a schematic diagram showing an example use of a media storage system shown in FIG. 6. In FIG. 7 (and in FIG. 8 described below) a simplified version of the transaction processor 210 is shown for clarity of the diagram.

In FIG. 7, the transaction processor 210 is connected via a network or Internet connection 320 to user data processing systems 330, 340 and 350 each operated (in this example) by separate corporate entities.

Each of the companies operating a client data processing system, or indeed other organisations altogether, may store media items on the disc array 230. Along side each media item, a schedule of proprietors of rights relating to that media item is stored. This may be stored at the disc array 230, at the asset management server 280 or elsewhere within the media server 220. Examples of the type of rights which are relevant to this arrangement are: the proprietor of copyright in the media item, the proprietor of a licence to the use of the media item, or an employee or contractor of one of these.

The list may be a simple schedule of names, electronic address, user identifiers or the like. Examples are given below, but other possibilities may of course be used. In some of the examples below, the media items are identified by SMPTE standard Unique Material Identifiers (“UMIDs”)

### Example 1

Item=Archive shot of Concorde fly-past, timecode A to timecode B

Proprietor=Davies, Gary

Proprietor=BBC News

Proprietor=BBC Enterprises

### Example 2

Item=Interview with Kenneth Clarke on Mar. 31, 2000; UMID=yyyyyyyyy

Proprietor=Channel5 News

Proprietor=Alan.Partridge@Peartree-Productions.co.uk

Proprietor=Conservative Central Office

### Example 3

Item =Draft internet home page for Skylark Industries, Inc

Proprietor=410.234.928.786

Proprietor =223.713.901.128

The basic principal is that users registered in the list of proprietors of rights associated with each media item are granted free access to that media item. Users not so listed are charged for access to the media item.

So, in operation, a client data processing system connects to the transaction processor 210 and identifies the user of the client data processing system to the media server 220. This identification process may be implicit, in that a connection along a particular dedicated data link is deemed to be a certain user, or may be explicit in that the client data processing system logs on and identifies itself to the transaction processor 210 at first connection. The client data processing system, which may be a conventional PC workstation running appropriate software to carry out the functions described here, is operable to issue a request to the transaction processor 210 for the transfer of a particular media item.

In response to such a request, the transaction processor 210 compares the identity of the user of the client data processing system with the schedule of proprietors for that media item held at the transaction processor 210. If the user is found in the schedule then the requested media item is transferred without charge or restriction. If the user is not found in the schedule then the requested item is still transferred but charging information is generated to issue, for example, an invoice to the user receiving the media item. The invoice may be based on charging information pre-set by the proprietor of the media item in question or may relate to a general set of access charges agreed with that user. The invoice or other charging information may be generated as, for example, an email or other electronic message or as a paper document to be forwarded by post.

In an alternative embodiment, access to the requested media item may be withheld until payment for the access charge is received in some form.

In a further alternative embodiment, the media server 220 also maintains a schedule of authorised users of each media item, this schedule including not only the proprietors of rights to that media item but also any other users authorised to have access to the media item. If a user attempts to request a transfer of that media item without that user appearing on the schedule of authorised users, the transfer is refused by the media server 220. If the user making the request does appear on the schedule of authorised users then a comparison is made with the schedule of proprietors of rights and the charging arrangements described above are put in place.

As a default position, all listed proprietors of an item are of course considered to be authorised users of that item.

In another variant of this embodiment, if a user does not appear on the list of authorised users then instead of the apparatus simply refusing the request for access straight away, the apparatus can send an electronic message, for example an e-mail message, to the listed proprietors of the requested item to ask whether the requesting user should be added to the list of authorised users. If the answer comes back as “no” from any of the proprietors, or if no response is received within a predetermined time such as one hour, then the request can be refused. Of course, the default position could be instead to allow the user to become authorised unless a negative response is received within the predetermined time. If, however, a positive response is received then the requesting user can be added to the list of authorised users and the procedure —with charging—continues as above. This process can be invisible to the requesting user, who just experiences a slight delay in having the request attended to. The requesting user need not know about the existence of the list of authorised users, nor whether that user is included or not included on the list.

FIG. 7 has shown the situation where three competing companies require access to media items which may be owned by one of the three companies or a third party. FIG. 8 shows another example of the user of this type of media storage system. As before, a media server 210 is connected via a network or Internet connection 320 to various client data processing systems. However, these are operated by different parties contributing to the production and output of a single media service such as a television program. So, a client data processing system may be operated by a production house 360, a post production organisation 370, an advertising agency 380 and a broadcaster 390.

When a program is being prepared, the production house 360 might prepare an initial edited program for storage at the media server 220. The production house is added to the list of proprietors of rights relating to that stored item. At a post-production stage, the post production organisation can download the program prepared by the production house 360, carry out post-production operations on the program and return it to the media server 210. Similarly, the advertising agency may access the program, add advertising material or carry out other functions and return the material to the media server 210. Finally, the broadcaster may issue a request to transfer the material to the broadcaster's client data processing system 390 for transmission. As the broadcaster is not listed as a proprietor of rights in the program, charging information is generated whereby the broadcaster 390 is invoiced for a copy of that program.

In so far as the embodiments of the invention described above are implemented, at least in part, using sofware-controlled data processing apparatus, it will be appreciated that a computer program providing such software control and a storage medium by which such a computer program is stored are envisaged as aspects of the present invention.

1. A multimedia transaction processor for facilitating the sale of multimedia material, said apparatus comprising
a media server operable to store multimedia material from at least one vendor, meta data representing the content of the multimedia material and data identifying the vendor providing the multimedia material, said meta data and said identifying data being stored in association with said multimedia material,
a communications processor connectable, via a communications link, to one or more data processing systems and operable to receive, via said communications link, from one of said data processing systems, data indicative of a request for multimedia content from a buyer,
an access processor operable to retrieve from said server possible multimedia material content items corresponding to said requested multimedia content by generating meta data from said data requesting said multimedia content and comparing said generated meta data with the meta data stored in association with said multimedia material, and from the comparison retrieving said possible multimedia content items from said server, and to communicate to the buyer data processing system data representative of said possible multimedia content items, and
a transaction controller operable, in response to selection data representative of a selection of at least one of said possible multimedia content items from said buyer, to communicate to said vendor identified by said stored identification, data ordering said selected multimedia content items, and to complete a sales transaction for the selected multimedia material with the buyer.

2. A multimedia transaction processor as claimed in claim 1, wherein said meta data comprises a plurality of different types, each different type of said meta data describing a different aspect of said multimedia content.

3. A multimedia transaction processor as claimed in claims 1 or 2, wherein the multimedia material stored in said media server is arranged to include impairments.

4. A multimedia transaction processor as claimed in claim 3, wherein said impairments are produced by generating a reduced quality representation of the material, to the effect that an amount of data required to represent the multimedia material is substantially reduced.

5. A multimedia transaction processor as claimed in any preceding claim, wherein said selection data includes an indication of a selected part of said selected multimedia item, said communications processor being operable in combination with said transaction controller to complete said sales transaction by debiting an amount of money corresponding to said selected part of said media item, with respect to the total cost of said selected media item.

6. A multimedia transaction processor as claimed in any preceding claim, wherein said server is arranged to store business rules data representative of the conditions for the sale of said selected multimedia material items, said access processor communicating said conditions of sale data to said buyer in response to one of said selection data and said requesting data.

7. A multimedia transaction processor as claimed in any preceding claim, wherein said access processor is operable in response to said selection data to generate and to store data representing the number of times buyers select said multimedia material items.

8. A multimedia transaction processor as claimed in claim 7, wherein said access processor is operable to determine the number of times multimedia content items owned by a particular vendor are selected by said buyers, and said communications processor is operable in combination with said access processor to communicate on request, data representative of said number of times said multimedia content items are selected, to said particular vendor providing said multimedia content.

9. A multimedia transaction processor as claimed in any preceding claim, wherein said access processor is operable to receive catalogue data representing a list of multimedia material items provided by a vendor divided into predetermined categories, said catalogue data being communicated on request to a buyer data processing system.

10. A multimedia transaction processor as claimed in any preceding claim, wherein said media server is arranged to store data representative of advertising material, and said access processor is operable to communicate said advertising data to said buyer data processing system in response to said request data.

11. A multimedia transaction processor as claimed in any of claims 2 to 10, wherein said request data comprises at least one data value and an indication of which of said types of meta data said data value corresponds, said access processor being operable to search said server for said possible multimedia content items by searching for values corresponding to said data value for said meta data type corresponding to said indication.

12. A multimedia transaction processor as claimed in any of claims 2 to 10, wherein said access processor is operable to generate at least one meta data value for at least one meta data type from said request data, and to retrieve said possible multimedia content items by searching said server for multimedia content items having meta data values corresponding to said at least one generated meta data value.

13. A multimedia transaction processor as claimed in any preceding claim, wherein said access processor is operable to compare said request data with meta data stored in said server and to retrieve meta data which corresponds with said request data, and to operate in combination with said communications processor to communicate said retrieved meta data to said buyer data processing systems, said access processor being operable to retrieve multimedia content items corresponding to selected retrieved meta data received from a buyer user data processing system.

14. A multimedia transaction processor as claimed in any preceding claim, wherein said transaction controller includes an account management system operable to store data representative of bank accounts of said buyer and said vendor, and consequent upon receipt of said selection data, to complete said transaction by transfering money to be charged to said bank account of said vendor from the bank account of said buyer, said amount of money being determined in dependence upon said pre-stored cost of buying said selected multimedia content items.

15. A multimedia transaction processor as claimed in any preceding claim, wherein said multimedia material includes one of data, video data, audio data and audio/video data.

16. A multimedia processing system comprising
a multimedia transaction processor as claimed in any preceding claim,
a plurality of data processing systems coupled to said transaction processor via a data communications network.

17. A multimedia processing system as claimed in claim 15, wherein said data communications network includes the Internet.

18. A method of vending multimedia material, said method comprising the steps of
identifying said multimedia material to be sold,
generating meta data describing the content of said multimedia material,
generating data representing a predetermined price for the sale of said multimedia material,
associating data representative of the owner of said multimedia material, with said multimedia material and said meta data,
arranging for said multimedia material, said meta data, said ownership data and said predetermined price for sale to be ingested by the media server of the multimedia transaction processor of any of claims 1 to 15,
arranging for buyers to establish a transaction account,
providing a facility for said buyers to preview said multimedia material, to select desired items of multimedia material and to complete a transaction for said selected multimedia material items using said transaction account,
arranging for said vendor to communicate said selected multimedia material items to said buyers.

19. A method of buying multimedia material using the transaction processor according to any of claims 1 to 15, comprising the steps of
establishing an account with the account management system of said multimedia transaction processor,
communicating data representative of a request for a desired multimedia material item to said transaction processor via a data communications network,
receiving possible multimedia material items from said transaction processor,
previewing said possible multimedia material items,
selecting desired multimedia items,
communicating data representative of said selection to said transaction processor,
completing a transaction for the purchase of said selected multimedia material items, and
arranging for the owner of said multimedia material to communicate said selected material items to said buyer.

20. A multimedia transaction processor comprising:
a media storage server storing a plurality of media items and data representative of one or more respective proprietors of rights relating to each item;
a data communications link;
one or more user data processing systems connectable via the data link to the media storage server, each user data processing system having means for identifying, to the media server, a user of that data processing system and to communicate request data to the media storage server representative of a request to transfer selected multimedia items stored in said media storage server to the requesting user data processing system, wherein said media storage server is operable, in response to said request data to transfer a multimedia item, to compare the identity of the requesting user with the proprietors of rights relating to the requested media item and, in the event that the user of the data processing system is not the proprietor of rights relating to the requested media item, to generate charging information relating to a charge to that user for transfer of the requested multimedia item.

21. A transaction processor as claimed in claim 20, wherein the multimedia items are audio/video or image media items.

22. A transaction processor as claimed in claim 20 or claim 21, wherein said media storage server is operable to maintain a copy of the requested media item at the storage server when a transfer to a user data processing system is made.

23. A transaction processor as claimed in any of claim 20 to 22, wherein the media storage server is operable to transfer the requested media item irrespective of the identity of the user of the client data processing system issuing the request.

24. A transaction processor as claimed in any one of claims 20 to 23, wherein said media storage server is operable to store data representing a list of users to which transfers of the media items are authorised, the storage server not transferring a media item to a user if that user does not appear on the list of authorised users for that media item.

25. A media storage server for storing a plurality of media items and ownership data representative of one or more respective proprietors of rights relating to each item, and charging data representative of the cost of selling said media items; said media storage server being connectable via a data communications link to one or more user data processing system, each user data processing system having means for identifying, to the storage server, a user of that data processing system and to communicate request data representative of a request to transfer media items held at the storage server to that user data processing system; said media storage server being operable, in response to a request from a user data processing system to transfer a media item, to compare the identity of the user of that user data processing system with the proprietors of rights relating to the requested media item and, in the event that the user of the data processing system is not the proprietor of rights relating to the requested media item, to generate charging information from said charging data relating to a charge to that user for transfer of the requested media item.

26. A method of media storage and retrieval, the method comprising the steps of:
storing, at a media storage server, a plurality of media items, data representing one or more respective proprietors of rights relating to each item and charging data representative of the cost of selling said media items;
connecting a user data processing system to the storage server via a data communications link;
the user data processing system identifying, to the storage server, a user of that user data processing system;
the user data processing system issuing requests to the storage server to transfer media items held at the storage server to that user data processing system;
the media storage server, in response to request data representative of a request for multimedia material from a user data processing system to transfer a media item, comparing the identity of the requesting user data processing system with the proprietors of rights relating to the requested media item and, in the event that the requesting user data processing system is not the proprietor of rights relating to the requested media item, generating charging from the charging data information relating to a charge to that user for transfer of the requested media item.

27. A method of operation of a media system, the method comprising the steps of:
storing a plurality of media items and data representative of one or more respective proprietors of rights relating to each item;
connecting to a user data processing system via a data communications link;
receiving from the user data processing system data identifying, to the storage server, the requesting user data processing system;
receiving from the requesting user data processing system request data representative of a request to transfer multimedia data items from the media storage server to that user data processing system;
in response to a request from a user data processing system to transfer a media item, comparing the identity of the requesting user data processing system with the proprietors of rights relating to the requested media item and, in the event that the requesting user data processing system is not the proprietor of rights relating to the requested media item, generating charging information from said charging data relating to a charge to that user for transfer of the requested media item.

28. A computer program providing computer executable instructions, which when loaded onto a computer configures the computer to operate as a multimedia transaction processor as claimed in any of claims 1 to 15.

29. A computer program providing computer executable instructions, which when loaded on to a computer causes the computer to perform the method according to claims 18, 19, 26 or 27.

30. A computer program product having a computer readable medium recorded thereon information signals representative of the computer program claimed in claims 28 or 29.

31. A media storage and retrieval method substantially as herein before described with reference to the accompanying drawings.

32. A method of operation of a media storage system, the method being substantially as herein before described with reference to the accompanying drawings.

33. A multimedia transaction processor and a multimedia transaction system as herein before described with reference to the accompanying drawings.

34. A method of vending and a method of buying multimedia material as herein before described with reference to the accompanying drawings.
